(19) United States
(12) Patent Application Publication
(10) Pub. No.: US 2025/0116249 A1
(43) Pub. Date: Apr. 10, 2025

(54) MAGNET ASSEMBLY FOR A FUEL INJECTOR, AND FUEL INJECTOR

(71) Applicant: Robert Bosch GmbH, Stuttgart (DE)

(72) Inventors: Felix Fehrer, Alkoven (AT); Friedrich Kroepl, Kronstorf (AT)

(21) Appl. No.: 18/730,063

(22) PCT Filed: Jan. 30, 2023
(86) PCT No.: PCT/EP2023/052121

§ 371 Date: Jul. 18, 2024

(30) Foreign Application Priority Data
Jan. 31, 2022 (DE) 10 2022 200 978.9

(51) Int. Cl. F02M 51/06

(52) U.S. Cl. CPC F02M 51/0625

(57) ABSTRACT

The invention relates to a magnet assembly (10) for a fuel injector (100), comprising an armature (26) which is arranged so as to be movable by lifting in the direction of a longitudinal axis (28) and is coupled to a valve element (42), wherein the valve element (42) is intended to open or close a hole (36), formed in a valve plate (35), for a pressure medium in the direction of a low-pressure region, wherein the first end face (43), facing the armature (26), of the valve element (42) abuts the end face (45), facing the first end face of the valve element, of the armature (26), and a pressure spring (20) applies a force to the armature (26) towards the first end face (43) of the valve element (42).

### BACKGROUND

The invention relates to a magnet assembly for a fuel injector, in which a magnet armature and a valve element which opens or closes a hole in the direction of a low-pressure region are formed as separate elements, wherein the valve element is arranged so as to be freely movable in a plane extending perpendicular to a longitudinal axis of the magnet assembly relative to the magnet armature. The invention also relates to a fuel injector with a magnet assembly designed according to the invention.

EP 3 469 207 B1 of the applicant discloses a magnet assembly with a magnet armature arranged so as to be movable by lifting. A residual air gap disk is arranged between the magnet armature and a magnet core with a magnet coil arranged in it. In order to prevent the residual air gap disk from adhering to the magnet armature due to adhesive forces during a lifting movement in the direction of a closed position of the magnet armature, the residual air gap disk is provided with a structure.

Furthermore, a magnet assembly for a fuel injector is known from DE 10 2009 003 208 A1 of the applicant, in which the magnet armature and a valve element are formed as separate components. The valve element is formed as a valve ball, which is positively accommodated in a spherical section-shaped surface of the magnet armature, so that the valve element is arranged in a fixed position in relation to the magnet armature in relation to a plane running perpendicular to a longitudinal axis of the magnet armature.

### SUMMARY

The magnet assembly according to the invention for a fuel injector has the advantage that the possibility of a relative movement between the valve element and the magnet armature in a plane running perpendicular to a longitudinal axis of the magnet armature allows an optimization of the installation space of the magnet armature chamber as well as an optimization of the material selection of the magnet armature to improve the magnetic force on the one hand and that of the valve element to optimize the sealing effect or wear on the other hand. For the functionality of such a solution, however, it is necessary that the valve element always follows the movement of the magnet armature when releasing the hole in the valve plate for the outflow of pressure medium in the direction of the low-pressure area. This is critical insofar as the end face of the valve element facing the valve plate abuts the valve plate in its position closing the hole, which generates adhesive forces that counteract the opening movement of the valve element. These adhesive forces between the valve element and the valve plate should therefore be reduced or minimized while maintaining the sealing effect of the valve element in its lowered position closing the hole, so that when the hole is released, the valve element follows the movement of the magnet armature or always abuts with its end face facing the magnet armature, the end face of the magnet armature facing it.

The invention is based on the idea of making this possible by structuring the valve plate on the side facing the valve element by reducing the lay-on or contact surface between the valve plate and the valve element in the position of the valve element closing the hole, so that the adhesive forces between the valve plate and the valve element are also reduced as a result. Structuring in the sense of the invention is understood to mean a surface that has regular or irregular depressions or similar surface elements that are produced by cutting or non-cutting.

Against the background of the above explanations, it is therefore provided according to the invention in a magnet assembly for a fuel injector that the latter has a magnet armature which is arranged so as to be movable by lifting in the direction of a stroke along a longitudinal axis and is coupled to a valve element, wherein the valve element serves to open or close a hole formed in a valve plate for a pressure medium in the direction of a low-pressure region, wherein the valve element abuts with its first end face facing the magnet armature, the end face of the magnet armature facing it and a pressure spring applies a force to the magnet armature in the direction of the first end face of the valve element, wherein the valve element is arranged movably relative to the magnet armature in a plane perpendicular to the longitudinal axis, and wherein a bearing surface of the valve plate facing the valve element is formed for the valve element with a structuring for reducing an adhesive force between the valve element and the valve plate.

In a particularly preferred design of the valve element, in which it can be manufactured particularly easily and precisely, it is provided that the valve element is pin-shaped with two flat end faces arranged opposite each other as viewed in the direction of the longitudinal axis, and that the second end face of the magnet armature is flat, at least in the overlapping region with the valve element. The flat, contacting end faces of the valve element and the magnet armature also allow the adhesion forces between the magnet armature and the valve element to be increased or optimized as desired. It is important here that the flat end faces of the magnet armature and the valve pin facing each other are particularly smooth or have a low surface roughness in order to support the opening movement of the valve element during an upward movement of the magnet armature or to ensure that the valve element is in constant contact with the magnet armature.

The structuring on the valve plate comprises at least one groove-like depression. The cross-section of the depression or the cross-sectional shape of the depression is formed according to the selected manufacturing method for forming the depression and is either rectangular, for example, or has a cross-section that increases or decreases in the direction of a groove base. In particular, such depressions can be produced either by a laser beam device or by machining processes.

In a geometrically preferred first embodiment of the structuring or depression, this is formed as a circular arc section or circle arranged concentrically around the longitudinal axis.

Alternatively or additionally, the depression can also be formed as a straight line.

A further embodiment of the invention provides for several depressions which at least partially intersect and thus form a grid pattern, for example.

Such depressions can either extend over the entire surface of the valve plate or only over a radially inner region of the valve plate. In the first case, in which the depressions also extend over the radially outer region of the valve plate, such depressions are particularly easy to produce with regard to the selected manufacturing process. In the second solution, in which the depressions extend in a radially inner region of the valve plate, it is advantageous if this region covers the entire region over which the valve element can move in the radial direction (in relation to the longitudinal axis).

Regardless of the shape, arrangement, and number of depressions, it is necessary that the required (hydraulic) sealing of the hole or outflow opening is made possible by the valve element when the valve element is in contact with the valve plate, i.e., that the depressions do not create a direct connection between the hole and the low-pressure region of the fuel injector.

A further preferred geometric configuration of the at least one depression is that it has a width of between 10 μm and 300 μm, preferably between 50 μm and 100 μm.

Furthermore, the invention also comprises a fuel injector, in particular a fuel injector for compression-ignition internal combustion engines, with a magnet assembly designed according to the invention as described above.

### BRIEF DESCRIPTION OF THE DRAWINGS

Further advantages, features, and details of the invention can be seen from the following description of preferred embodiments of the invention and from the drawings.

FIG. 1 shows a longitudinal section through a fuel injector in the region of a magnet assembly,

FIG. 2 to FIG. 4 Top views of different structures formed in the region of a valve plate of the magnet assembly, and

FIG. 5a to FIG. 5e longitudinal sections in the region of differently formed groove-like depressions of the structures.

### DETAILED DESCRIPTION

Identical elements or elements with the same function are provided with the same reference signs in the figures.

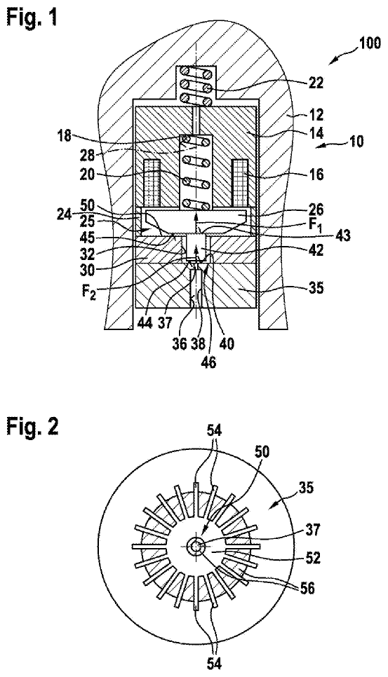

FIG. 1 shows a partial region of a fuel injector 100, not shown in detail, for a compression-ignition internal combustion engine in the region of a magnet assembly 10. The magnet assembly 10 is arranged within a valve housing 12 and comprises a magnet core 14 with an electrically energizable magnet coil 16 arranged in a radially circumferential groove. The magnetic core 14 has a stepped hole 18, wherein a first pressure spring 20 is arranged in a section of the stepped hole 18 with a larger diameter. A second pressure spring 22 acts on the magnet core 14 on the end face facing it and presses the magnet core 14 in the direction of a spacer ring 24 arranged in a fixed position in the valve housing 12. The spacer ring 24 radially surrounds a magnet armature chamber 25, wherein a flat or disk-shaped magnet armature 26 is arranged in the magnet armature chamber 25 in the exemplary embodiment. The end face of the first pressure spring 20 facing the magnet armature 26 is in contact with the magnet armature 26 and presses the magnet armature 26 in the direction of a longitudinal axis 28 of the magnet armature 25 or in the direction of a closed position. In contrast, when the magnet coil 16 is energized, the magnet armature 26 is moved in the direction of the magnetic core 14 against the spring force of the first pressure spring 20.

Viewed in the direction of the longitudinal axis 28, the spacer ring 24 is adjoined, for example, by a guide ring 30 with a through hole 32 formed concentrically to the longitudinal axis 28. On the side of the guide ring 30 facing away from the spacer ring 24, there is a valve plate 35 arranged in a fixed position in the valve housing 12.

The valve plate 35 has a hole 36 formed concentrically to the longitudinal axis 28, wherein the hole 36 has a first section 37 on the side facing the guide ring 30. The first section 37 is followed by a second section 38, which has a larger diameter than the first section 37. In particular, the hole 36 forms a control chamber with pressurized fuel of the fuel injector 100, which serves to move a valve member (nozzle needle) not shown in the figure in order to enable fuel to be injected into the combustion chamber of the compression-ignition internal combustion engine, as is known per se.

For closing or opening and releasing the hole 36, which serves as an outflow hole in the direction of a low-pressure region or to the magnet armature chamber 25, the valve plate 35 forms a bearing surface 40 on the end face facing the magnet armature chamber 25, which interacts with a valve element 42.

The valve element 42 is formed as a cylindrical valve element 42 and has a first end face 43 on the side facing the magnet armature 26 and a second end face 44 on the side facing the valve plate 35, which each extend as flat end faces 43, 44 perpendicular to the longitudinal axis 28.

The material of the valve element 42 is optimized with regard to its wear, for example by providing the valve element 42 with a coating. In contrast, the magnet armature 26 is made of a different material compared to the valve element 42, for example to optimize the magnetic properties in interaction with the magnetic core 14 or the magnet coil 16.

The valve element 42 is arranged with radial play in the through hole 32 of the guide ring 30, so that the valve element 42 is arranged so as to be movable or displaceable (radially) in a plane extending perpendicularly to the direction of the longitudinal axis 28, and abuts radially movably only with its first end face 43, the end face 45 of the magnet armature 26 facing it. Furthermore, the bearing surface 40 of the valve plate 35 is formed as a sealing region 46 in the region in which the valve element 42 rests with its second end face 44 when the spring force of the first pressure spring 20 applies a force to the valve element 42 via the magnet armature 26.

For the function of the magnet assembly 10, in particular for the controlled release or closure of the first section 37 of the hole 36 when the magnet coil 16 is energized, it is essential that the valve element 42 follows the lifting movement of the magnet armature 26, i.e., that the valve element 42 with its first end face 43 always abuts the end face 45 of the magnet armature 26.

For this purpose, it is essential that when the magnet armature 26 and the valve element 42 are moved in the direction of the magnet core 14 from the position closing the hole 36 to open the hole 36, the adhesion force F₁ formed as a result of hydraulic effects between the valve element 42 and the magnet armature 26 in the contact region, which acts in the direction of the magnet armature 26, is always greater than the adhesion force F₂ formed between the valve plate 35 and the second end face 44 of the valve element 42, which acts in the direction of the valve plate 35. To ensure this, the valve plate 35 has a structure 50 on the side facing the valve element 42 in the region of the bearing surface 40.

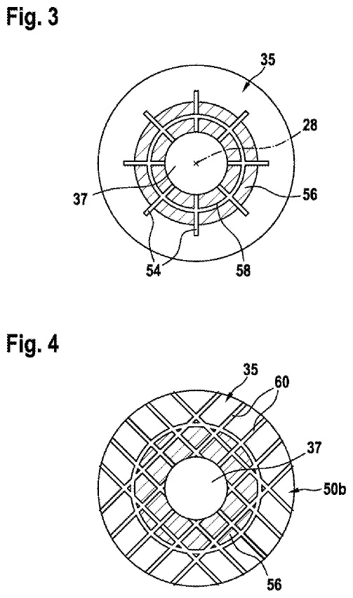

In a first embodiment of such a structuring 50, shown in FIG. 2, the structuring 50 has an annular depression 52 in relation to the longitudinal axis 28, which is adjoined by depressions 54 extending from the depression 52 in a straight line in the radial direction, which are each aligned with the longitudinal axis 28. The depressions 54 formed as a straight line extend from the depression 52 only over a partial region of the surface of the valve plate 35, i.e., they extend only over a radially inner region of the valve plate 35. The hatched region 56 in FIG. 2 indicates the region of the lay-on or the contact surface between the second end face 44 of the valve element 42 and the valve plate 35. In particular, it can be seen that the depressions 54 extend over the entire hatched region 56 when viewed in the radial direction. This ensures that the valve element 42 is still located in the region of the structuring 50 even in the event of a (slight) radial movement due to its mobility relative to the magnet armature 26.

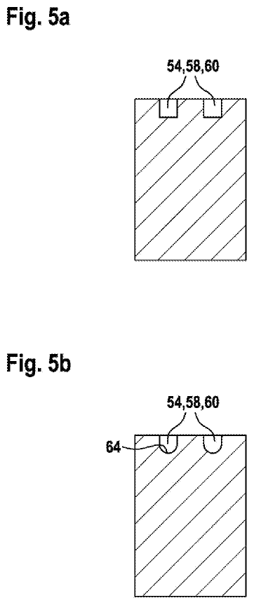

FIG. 3 shows a further structuring 50a. In addition to the depressions 54 formed as a straight line, the structuring 50a comprises a circular depression 58 running concentrically around the longitudinal axis 28.

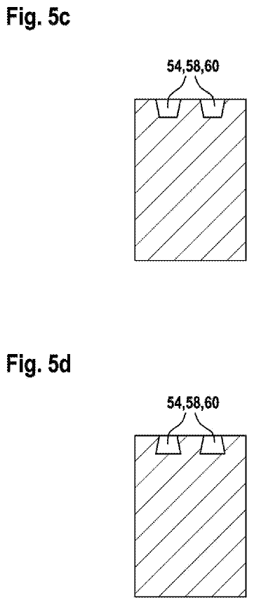

FIG. 4 shows a structuring 50b which has a plurality of intersecting depressions 60 formed as straight lines and arranged in the form of a grid 62.

The depressions 54, 58, and 60 are produced as groove-shaped depressions 54, 58, and 60, for example by means of a laser beam device, by a chemical (deburring) process, or by machining. The cross-sectional shape of the depressions 54, 58, and 60 can be formed in a variety of ways. Preferably, the depressions 54, 58, and 60 have a depth of between 10 μm and 30 μm, preferably about 20 μm. The groove depth is influenced by the expected wear and the manufacturing process. Furthermore, the groove depth is important with regard to the formation of the adhesion force F₂ between the valve element 42 and the valve plate 35 in that at least one depression 54, 58, and 60 must always interrupt the bearing surface 40. The groove width of the depressions 54, 58, and 60 is essentially determined by the manufacturing process of the depressions 54, 58, and 60 and can therefore exhibit a relatively wide range of variation. Preferably, the depressions 54, 58, and 60 have a width of between 10 μm and 300 μm. The groove width is important with regard to the adhesion force F₂ between the valve element 42 and the valve plate 35 insofar as many small residual surfaces enable sufficient robustness against wear with a simultaneously low adhesion force F₂.

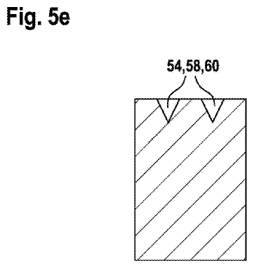

According to FIG. 5a, the depressions 54, 58, and 60 described above may, for example, have a rectangular cross-section. In FIG. 5b, on the other hand, the cross-section of the depressions 54, 58, and 60 is formed with a rounded groove base 62. FIG. 5c shows that the cross-section of the depressions 54, 58, and 60 can be formed as a funnel section. FIG. 5d shows a cross-section of the depressions 54, 58, and 60, which is arranged as in FIG. 5c, but in the opposite arrangement of the funnel-section-shaped depressions 54, 58, and 60. Finally, FIG. 5e shows triangular depressions 54, 58, and 60 in cross-section.

1. A magnet assembly (10) for a fuel injector (100), having a magnet armature (26) which is arranged so as to be movable by lifting in a direction of a longitudinal axis (28) and is coupled to a valve element (42), wherein the valve element (42) serves to open or close a hole (36) formed in a valve plate (35) for a pressure medium in a direction of a low-pressure region, wherein the valve element (42) abuts with a first end face (43) facing the magnet armature (26), an end face (45) of the magnet armature (26) facing the valve element (42) and a pressure spring (20) applies a force to the magnet armature (26) in a direction of the first end face (43) of the valve element (42), wherein the valve element (42) is arranged movably relative to the magnet armature (26) in a plane perpendicular to the longitudinal axis (28), and wherein a bearing surface (40) of the valve plate (35) facing the valve element (42) is provided with a structuring (50; 50a; 50b) for reducing an adhesive force (F2) between the valve element (42) and the valve plate (35).

2. The magnet assembly according to claim 1
wherein
the valve element (42) is formed as a pin with two flat end faces (43, 44) arranged opposite one another as viewed in the direction of the longitudinal axis (28), and wherein the end face (45) of the magnet armature (26) is flat, at least in a region of overlap with the valve element (42).

3. The magnet assembly according to claim 1,
wherein
the structuring (50; 50a; 50b) on the valve plate (35) comprises at least one depression (54, 58, 60).

4. The magnet assembly according to claim 3,
wherein
the at least one depression (58) is formed as a circular arc section or circle arranged concentrically around the longitudinal axis (28).

5. A magnet assembly according to claim 3,
wherein
the at least one depression (54, 60) is formed as a straight line.

6. A magnet assembly according to claim 3,
wherein
several depressions (60) are provided which at least partially intersect.

7. The magnet assembly according to claim 6,
wherein
the depressions (54, 58, 60) extend over an entire surface of the valve plate (35) on a side including the bearing surface (40).

8. The magnet assembly according to claim 6,
wherein
the depressions (54, 58, 60) extend only over a radially inner region of the valve plate (35) on a side including the bearing surface (40).

9. A magnet assembly according to claim 3,
wherein
the at least one depression (54, 58, 60) has a width of between 10 μm and 300 μm.

10. A fuel injector (100), comprising a magnet assembly (10) according to claim 1.

11. The magnet assembly according to claim 3, wherein the at least one depression (54, 58, 60) is a groove-like depression.

12. The magnet assembly according to claim 9, wherein the at least one depression (54, 58, 60) has a width of between 50 μm and 100 μm.
